(19) United States
(12) Patent Application Publication
(10) Pub. No.: US 2007/0068554 A1
(43) Pub. Date: Mar. 29, 2007

(54) CAR WASH TIRE APPLICATOR AND RELATED METHOD

(75) Inventor: Ryan J. Essenburg, Holland, MI (US)

Correspondence Address: WARNER NORCROSS & JUDD LLP, 900 FIFTH THIRD CENTER, 111 LYON STREET, N.W., GRAND RAPIDS, MI, 49503-2487, US

(73) Assignee: VQ, INC., Holland, MI (US)

(21) Appl. No.: 11/533,955

(22) Filed: Sep. 21, 2006

Related U.S. Application Data
(60) Provisional application No. 60/720,301, filed on Sep. 23, 2005.

(51) Int. Cl. B08B 7/04; B08B 7/00; B08B 3/00

(52) U.S. Cl. 134/18; 134/198; 134/123; 134/137; 134/34; 134/33; 134/56 R

(57) ABSTRACT

A car wash tire applicator including a movable follower and a sprayer. The follower moves alongside a vehicle and the sprayer sprays a treatment liquid on a tire of the vehicle, optionally toward the bottom portion of the tire of the vehicle as the tire rotates. The sprayer continues to spray until substantially all of an exposed side of the tire is treated. In one embodiment, the sprayer is aimed and sprays a substantially linear region across the tire adjacent the lowermost portion of the rim to which the tire is attached. The sprayer can include a fan nozzle and can be positioned disposed at an angle of about 0° to about 10° from horizontal. A related method includes moving a sprayer, optionally aimed at a bottom portion of a vehicle tire, alongside the vehicle as the vehicle moves on a travel path, and spraying the tire with a treatment liquid.

This application claims the benefit of U.S. Provisional Patent Application 60/720,301, filed Sep. 23, 2005, which is hereby incorporated by reference.

### BACKGROUND OF THE INVENTION

The present invention relates to car wash equipment, and more particularly to a car wash tire applicator.

Automated car washes have become increasingly popular due to their efficiency and cost effectiveness. Most automated car washes include multiple pieces of equipment that wash or treat different parts of a vehicle. For example, one piece of equipment cleans vehicle body panels, and another cleans or otherwise treats the tires of a vehicle.

The pieces of car wash equipment that cleans and/or treat tires are called tire applicators. Tire applicators usually are adapted to apply treatment liquids, for example, chemicals, water, foam soap and/or other liquids, to remove road grime, dirt and brake dust from the tires. Tire applicators can also be used to apply chemicals to tires to give them a glossy appearance.

Tire applicators typically comprise a stationary fixture include a chemical supply, a pump, a sensor and multiple nozzles. As a vehicle drives past the stationary fixture, the sensor detects the presence of the tire and actuates the pump to spray the rim and tire with a treatment liquid, which is projected through the nozzles.

Although conventional tire applicators provide a way to apply treatment liquid to tires, they suffer a number of shortcomings. First, the amount of treatment liquid applied to a tire is metered by the speed of the vehicle as it passes the stationary fixture. If the vehicle moves too quickly, there is insufficient treatment liquid sprayed on the tire to adequately clean and/or treat the tire. Second, conventional tire applicator spray nozzles spray multiple parts of a wheel, that is, both the tire and the rim, as the vehicle passes the stationary fixture. This wastes material, and can be particularly costly when highly specialized tire glosses are used. Additionally, some chemicals are over-sprayed onto the rim. If caustic, those chemicals can tarnish or damage the rim. Third, treatment liquid is randomly sprayed on the tire due to the stationary positioning of the nozzles. This, too, can waste treatment liquids. Fourth, because of the stationary nature of the tire applicator and movement of the car, there is frequently an insufficient amount of contact time for the applicator to apply the treatment liquid to the tire and adequately treat the tire.

### SUMMARY OF THE INVENTION

The aforementioned problems are overcome in the present invention by a car wash tire applicator including a movable follower including a sprayer. The follower moves alongside a moving vehicle, and as a tire of the vehicle rotates, the sprayer sprays treatment liquid on the tire so that the whole tire is treated.

In one embodiment, the sprayer can be a spray nozzle that sprays a fan of treatment liquid across a portion of the tire as the tire rotates on the moving vehicle. Optionally, the portion is the bottom part of the tire.

In another embodiment, the follower can move alongside the vehicle, and the sprayer can spray the bottom portion of the tire until the tire rotates a substantial part of one revolution so that the whole tire is treated with the treatment liquid.

In a further embodiment, the follower can be mounted to a guide rail adjacent a travel path of a vehicle. The follower can move along the guide rail adjacent a tire of the vehicle traveling alongside the guide rail to apply treatment liquid to the tire.

In yet another embodiment, the applicator can include a control unit. The control unit can control the follower to follow a first tire of the vehicle for a selected distance, and then control the follower to return and follow a second tire of the vehicle to treat both the first and second tires.

In another embodiment, the spray nozzle can include multiple heads that spray treatment liquid on a tire in various locations. Optionally, the multiple heads can rotate relative to the follower.

In another aspect, a method is provided for applying a treatment liquid to a tire of a vehicle. The method includes sensing a vehicle moving along a travel path; actuating a sprayer to spray the treatment liquid as the vehicle travels along the travel path; and moving the sprayer along side the vehicle so that the sprayer sprays the tire as the tire rotates. Optionally, the sprayer sprays substantially only the bottom portion of the tire as the tire rotates so that the entire exposed outer surface of the tire is treated with the treatment liquid.

The present tire applicator provides a simple and efficient way to apply treatment liquids to vehicle tires. Where the follower follows alongside the vehicle and the spray member sprays treatment liquids on the bottom portion of a passing vehicle tire, the treatment liquid can be applied to efficiently treat the tire. This can save treatment liquid and reduce the cost of operating the tire applicator. Because the follower moves alongside the tire of a moving vehicle, the contact time provided to apply treatment liquid can be increased, which can improve the treatment provided by the treatment liquid. Furthermore, where the spray member is targeted on the bottom portion of the tire across the tire immediately below and/or adjacent the lowermost portion of the rim, to which the tire is mounted, the treatment liquid can be applied efficiently. Accordingly, the amount of treatment liquid used can be reduced.

These and other objects, advantages and features of the invention will be more readily understood and appreciated by reference to the detailed description of the invention and the drawings.

### BRIEF DESCRIPTION OF THE DRAWINGS

FIG. 1 is a side view of the tire applicator including followers at a start position;

FIG. 2 is a side view of the tire applicator with the followers at an end position;

FIG. 3 is a side view of the tire applicator applying treatment liquid to a first tire of the vehicle at the start position;

FIG. 4 is a side view of the tire applicator continuing to apply treatment liquid to the first tire of the vehicle;

FIG. 5 is a side view of the tire applicator continuing to apply treatment liquid to the first tire to the end position;

FIG. 6 is a side view of the tire applicator returning to the start position and applying treatment liquid to a second tire of the vehicle;

FIG. 7 is a perspective view of a sprayer of the tire applicator applying treatment liquid to a tire of the vehicle;

FIG. 8 is a top plan view of the tire applicator in a car wash;

FIG. 9 is a front view of a controller of the tire applicator; and

FIG. 10 is a perspective view of an alternative embodiment of the tire applicator.

### DETAILED DESCRIPTION OF THE INVENTION

I. Overview

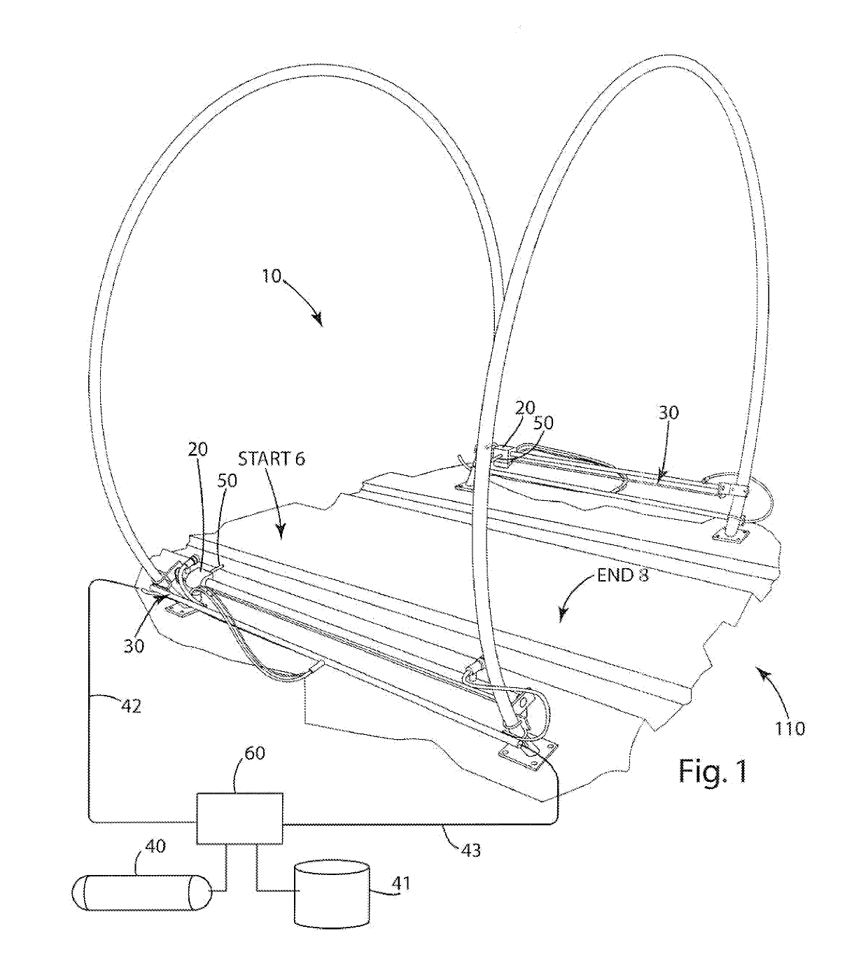

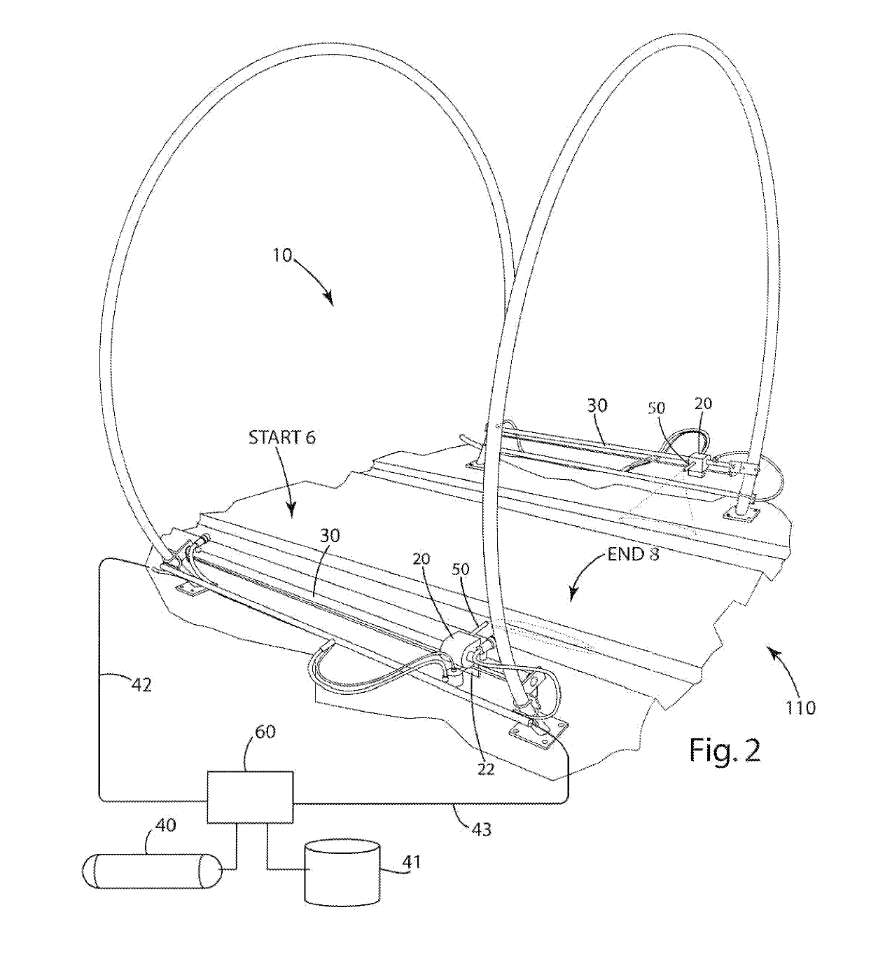

A first embodiment of a car wash liquid treatment applicator is shown in FIGS. 1-9 and generally designated 10. The tire applicator 10 can include a follower 20, a support 30, a treatment liquid supply 41, an air supply 40, a sprayer 50 and a control 60. The follower can move on the support 30 adjacent a vehicle 100 as the vehicle travels along a travel path 110. The control 60 can initiate and control the movement of the follower 20 alongside the vehicle and/or tire 120 of the vehicle 100. A supply of treatment liquid is in fluid communication with the sprayer 50. Optionally, under the control of the control 60, the sprayer 50 can spray the treatment fluid 150 on the lower portion of the tire as the tire rotates so that the whole tire is treated with the treatment liquid. As shown, the “whole tire” can be the entire outer sidewall or surface of the tire. As used herein, “treatment liquid” refers to liquids, chemicals, such as tire gloss, tire treatments, soap, water, foam, and any combinations of the foregoing. As shown in FIGS. 1 and 2, one or more opposing tire applicators 10 can be provided on opposite sides, the driver side and the passenger side, of a vehicle path 110 to treat or clean tires on both sides of the vehicle.

II. Construction

The components of the tire applicator 10 will now be described in detail with reference to FIGS. 1-9. As noted above, the applicator 10 can include a follower 20, a support 30, a treatment liquid supply 41, an air supply 40, a sprayer 50 and a control 60.

With reference to FIGS. 1-5 and 8, the follower 20 is mounted on support 30. The follower 20 includes a plate 22 joined with a guide 24. The guide 24 is movably and slidably mounted to a guide rail 32. The guide 24 may include fittings such as polypropylene, metal bearings or other materials to minimize friction between it and the guide rail 32. The follower 20 and support 30 are constructed so that the guide 24 moves on the guide rail 32 alongside a vehicle 100 as the vehicle travels along its travel path 110.

The guide rail 32 forms a part of the support 30. The guide rail 32 can be further secured to support structures 36, which as shown, can be bolted to the ground or another structure.

The support 30 can further include a second guide rail 34 positioned adjacent and parallel to the first guide rail 32. In addition, a secondary guide element 37 can be joined with the plate 22 and can extend generally between the guide 24 and the secondary guide rail 34. This guide element 37 can be constructed of a low friction, durable material, such as polypropylene or other synthetic polymers, and can slide or move in a consistent manner relative to the guide rail 34. The element 37 can be a ringed element that circumterentiates the rail 34. In general, the guide element 37 moves relative to the rail 34, and the two cooperate to assist in aligning the plate 22 with the travel path 110, vehicle 100 and/or a desired reference plane, for example, a vertical plane. Other suitable constructions can be used as desired.

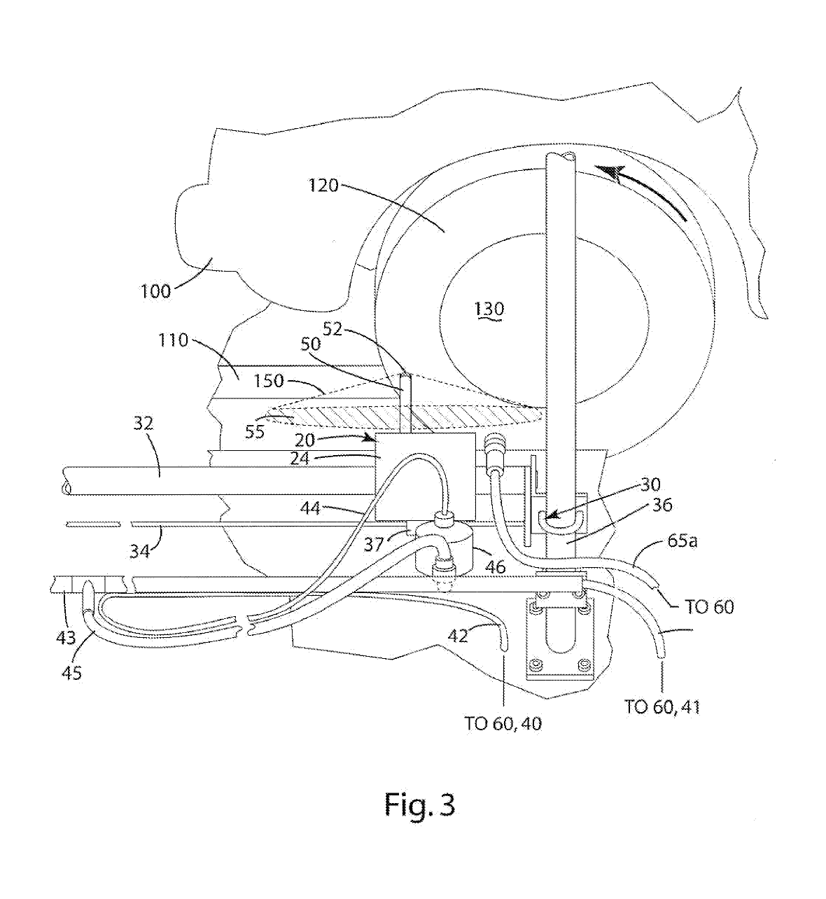

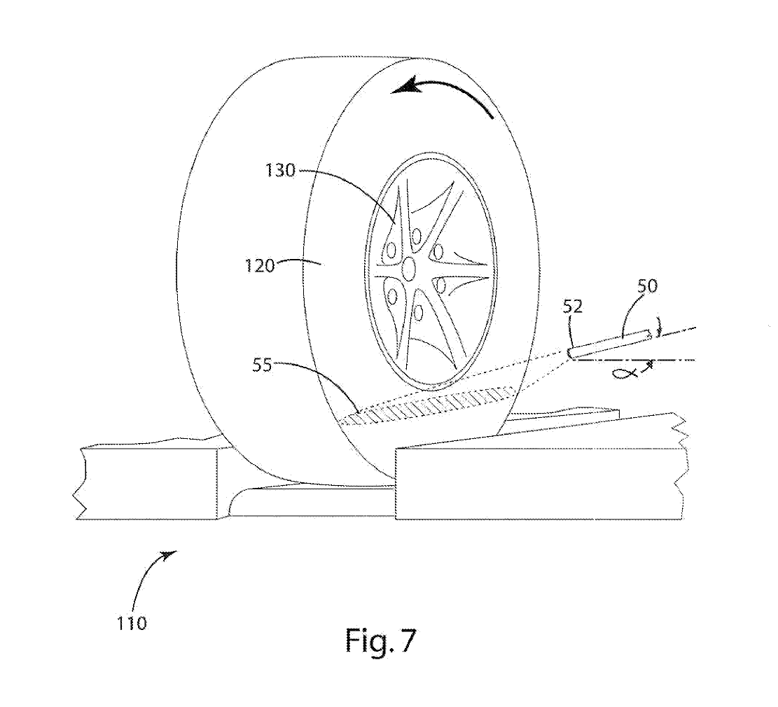

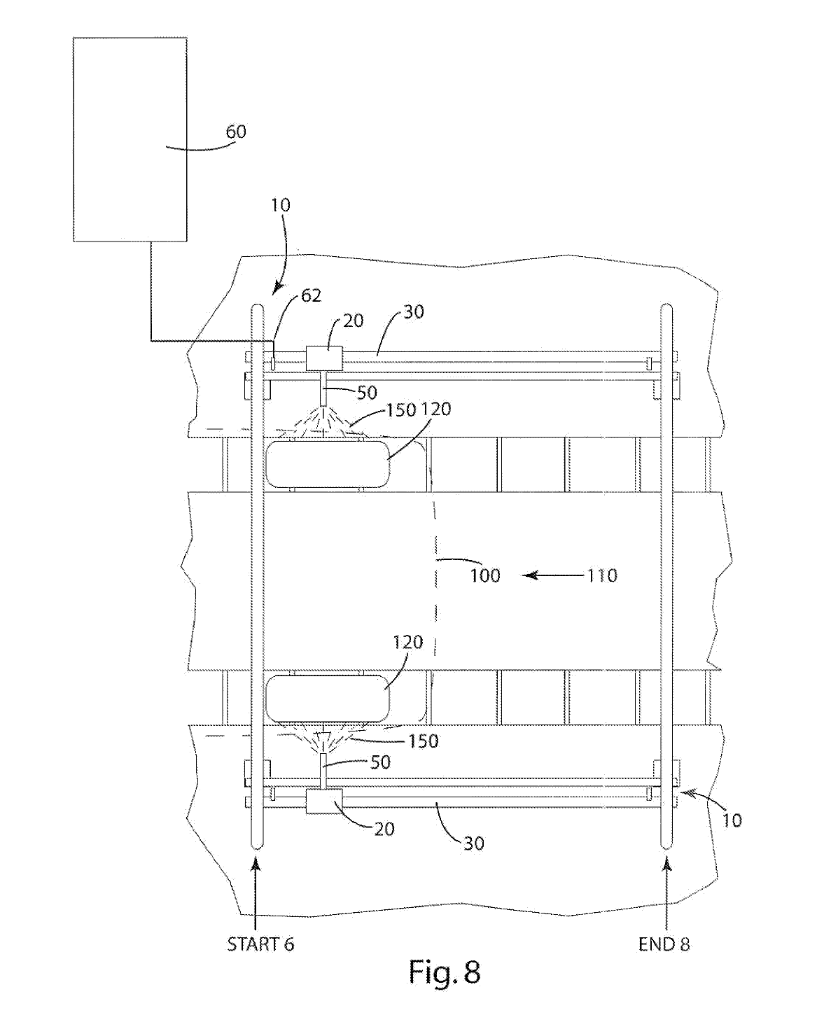

As shown in FIGS. 1-7, the follower 20 also can have mounted to it a sprayer 50. The sprayer 50 can be in fluid communication with a pump 46, also optionally mounted to the guide 24. Optionally, the sprayer projects from the plate 22. The sprayer 50 can include a nozzle 52. This nozzle can provide any desired spray pattern, for example, a cone pattern spray, a fan pattern or other patterns as desired. In one embodiment, the nozzle is a fan spray nozzle which projects a linear spray pattern of treatment liquid 150. As shown in FIGS. 3-5, this linear spray pattern can be in the form of an ellipse with its major axis generally horizontal. As shown in FIG. 7, the fan nozzle can be positioned at an angle α of about 0°, about 5°, about 10°, or a range of about 0° to about 10° relative to horizontal or any other desired angle. The spray nozzle 52 can be aimed at the location immediately adjacent or at the lowermost portion of the rim 130 to which the tire 120 is secured. This can correspond to region 55, which extends generally linearly across the largest surface area of the tire 120 without contacting the rim. This region 55 is generally referred to as the “sweet spot.” As noted above, the follower 20 follows alongside the vehicle 100 so that the sprayer 50 sprays the tire 120 as shown in FIG. 8. Because the tire rotates completely (that is, one full rotation) after a certain distance of travel by the vehicle, the whole exposed outer sidewall of the tire 120, e.g., the “whole tire,” is treated with the treatment fluid 150.

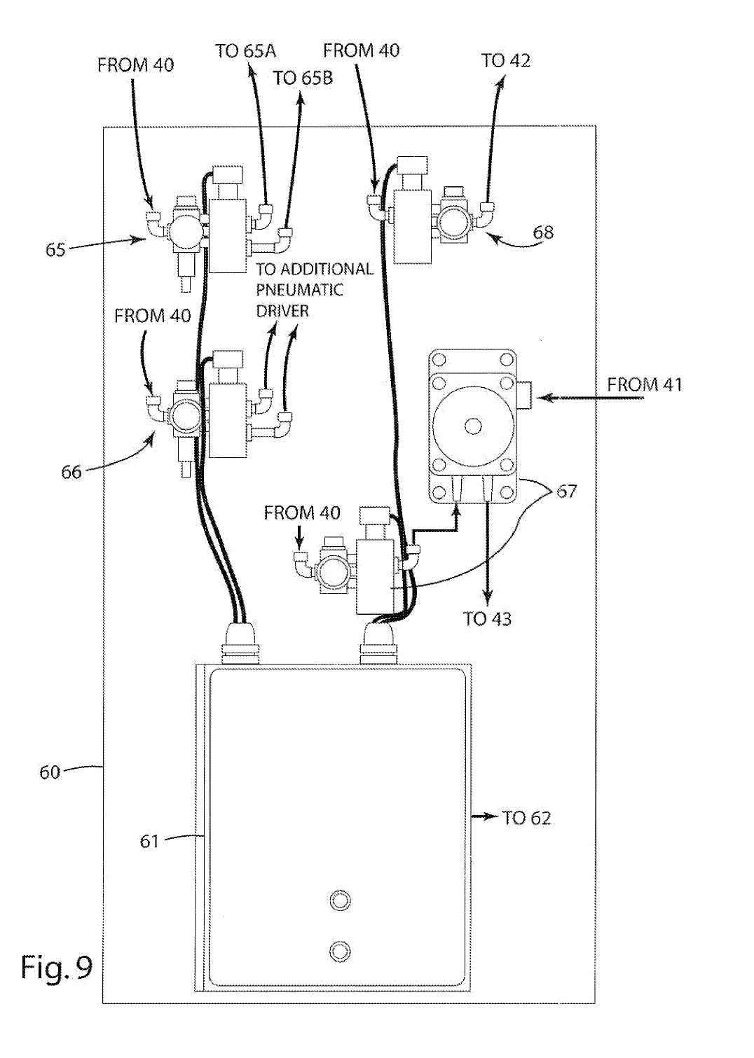

With reference to FIGS. 3-5 and 8, the guide rail 32 is generally aligned with the vehicle path 110. The movement of the guide 24 along the guide rail 32 can be effected by any suitable drive mechanism. As shown in the embodiments of FIGS. 1-9, the drive mechanism is a pneumatic system, for example a Magnaglide air lift cylinder, available from Airlift Doors, Inc. of Minneapolis, Minn. The pneumatic system is plumbed into a control 60 (FIG. 9) via control tubes or lines 65a and 65b. The control includes a processor 61 which controls the pneumatic system valve 65 to regulate air provided by the air supply 64 to and from the air line 65a and 65b. When pressurized, the line 65a urges the driver side follower to move forward in the direction of the vehicle travel. During this forward travel, the line 65b is not pressurized. To reverse the travel of the follower 20 on the guide rail 32, the processor 61 controls the valve 65 so that line 65b is pressurized and line 65a is not. Accordingly, the follower moves in a direction opposite the travel of the vehicle along the guide rail 32. A similar pneumatic system can be used on the passenger side to enable the tire applicator 10 to appropriately treat a tire with a treatment liquid. Any alternative plumbing system can be designed to transfer air to the guide rail and/or follower to move the follower relative to the rail.

As a substitute to the pneumatic system shown, the follower 20 can be driven by or included on a chain or conveyor (not shown) aligned with the vehicle path 110. In another suitable substitute, the follower 20 can be joined with the guide rail 32 in a gear-to-rack configuration. Many other drive mechanisms are suitable for moving the follower 20 alongside the vehicle 100 to apply treatment liquid to the vehicle tire 120.

As shown in FIGS. 1-9, the sprayer 50 is in fluid communication with a liquid treatment supply 41 and/or an air supply 40. Specifically, the stationary line 43 and flexible line 45 are in liquid communication with the liquid treatment supply 41. These tubes supply a treatment liquid from the liquid treatment supply 41 to the solenoid pump 46. The stationary line 42 and flexible line 44 are also in fluid communication with the air supply 40. These tubes 42, 44 deliver air from the air supply 40 to the pump solenoid 46 to operate the pump solenoid. When the pump solenoid 46 is activated by pressurized air in the line 44, treatment liquid passes through the pump solenoid 46 and is discharged in the form of a spray of treatment liquid 150 from the sprayer 50. Optionally, the pump solenoid can be absent from the applicator 10 as the application requires. In which case, flow of the treatment liquid from the liquid treatment supply 41 to the lines 43, 45 and out the sprayer 50 can be controlled by other valve-like systems that regulate the timing and pressure of treatment liquid sprayed from the sprayer 50.

As shown, the stationary lines 42 and 43 extend about half the length of the guide rail 32. The flexible tubes 44 and 45 are joined to the ends of the tubes 42 and 43 so that the follower 20 can extend from the start position 6 to the end position 8. Other suitable tubing configurations can be used depending on the application.

With reference to FIGS. 1-3, 8 and 9, the control 60 will be described in connection with delivery of treatment liquid from the liquid treatment supply 41 to the sprayer 50. The control can include a feeder 67 that is in fluid communication with the liquid treatment supply 41. This feeder 67 can be controlled by the processor 61 of the control 60. In operation, air from the air supply 40 can be fed into the feeder 67 to pump or assist in pumping treatment liquid from the liquid treatment supply 41 through the stationary line 43 to the flexible line 45, subsequently to the pump solenoid 46, which meters the treatment liquid sprayed from the sprayer 50.

The pump solenoid 46 is controlled by another component of the control 60, the pump solenoid operator 68. The pump solenoid operator 68 is in communication with the processor 61 which controls is operation. The pump solenoid operator 68 facilitates transfer of air from the air supply 40 through the stationary line 42 and flexible line 44, and subsequently to the pump solenoid 46 for operation thereof, for example, to open and close the solenoid, allowing treatment liquid 150 to spray from sprayer 50.

With reference to FIGS. 1-3, 8 and 9, the control 60 can include one or more drive system control valves 65, 66 which control air flow from air supply 40 to the forward and reverse lines 65a, 65b of a pneumatic drive system as described above. The drive system control valves 65, 66 can be in communication with and operated by processor 61 to move the follower 20 along side the vehicle 100 to apply a treatment liquid to the vehicle tire as the vehicle moves along the vehicle path 110.

With reference to FIGS. 8 and 9, the control 60, in particular the processor 61, can be connected to one or more sensors 62. The sensor 62 can detect when a tire and/or other vehicle component comes into proximity to the tire applicator 10. Via the sensing of the tire 120 or component, the controller can initiate the sprayer so that the sprayer 50 begins to spray treatment liquid 150 on the tire 120. With the sensor 62, the control 60 optionally can determine the speed of the vehicle as it passes alongside the guide rail 32. Accordingly, the control 60 can adjust the speed of the follower 20 by manipulating the drive system control valves 65, 66 so that the follower moves adjacent the tire 120, and the sprayer 50 sprays a desired portion of the tire.

The controller can include an internal timer (not shown) which maintains the valves open and pump solenoid 46 operating to pump treatment liquid through the sprayer 50. After a predetermined amount of time, the controller closes the valves, and disengages the pump solenoid 46 so that the treatment liquid is no longer sprayed through the sprayer 50. The control 60 also can operate the pneumatic system to return the follower to the start position.

III. Operation and Method

With reference to FIGS. 1-9, the operation of the tire applicator will now be described. In operation, a vehicle 100 approaches the tire applicator 10, specifically, the start position 6. A sensor 62 in communication with the control 60 detects the presence of the first tire 120. The sensor then sends a signal to the control 60. In response, the control 60 generally opens the drive system control valves 65, 66 to move the followers 20, and also opens the pump solenoid valve 46 and the feeder 67, so that treatment liquid 150 is sprayed from the sprayer 50.

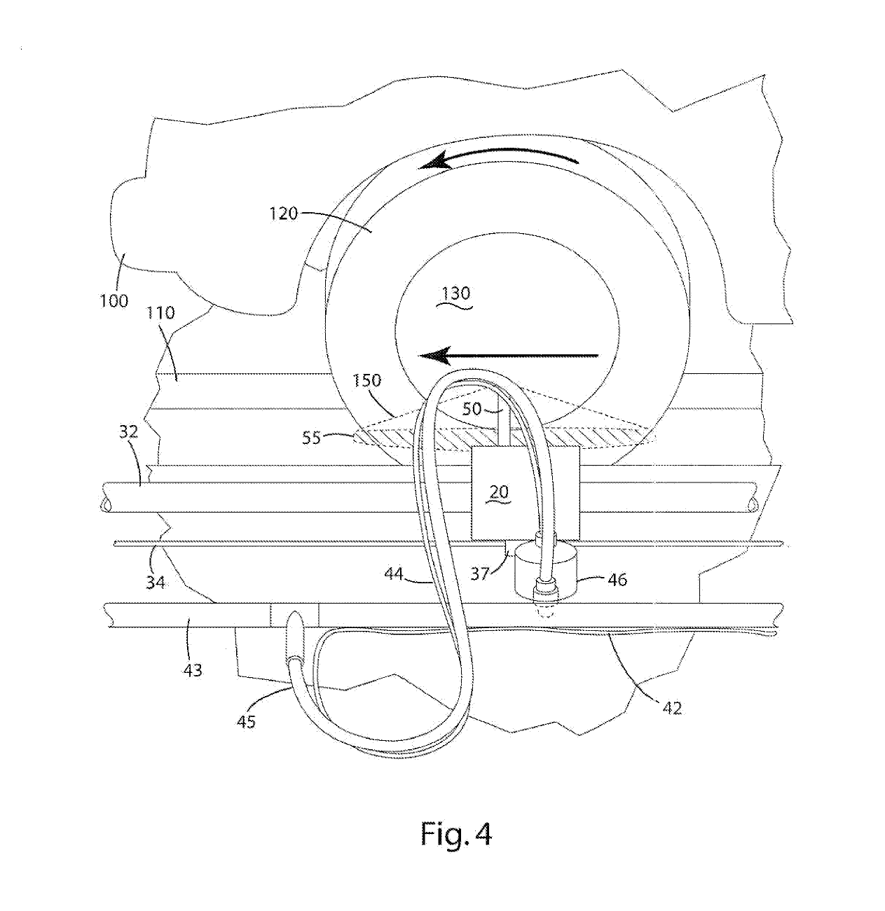

Specifically, the control 60 actuates the follower 20 via drive system control valves 65, 66 (FIG. 9), so that as the vehicle travels along the travel path 110 alongside the guide rail, the follower 20 moves about the same speed as the vehicle 100. The control 60 also actuates the feeder 67 and solenoid valve 68, to subsequently open the pump solenoid 46 and feed treatment liquid out the sprayer 50. Accordingly, the sprayer 50 begins spraying a treatment fluid 150 (FIG. 7) on the tire. As the vehicle 100 travels along the guide rail 32 with the tire 120 rotating, the follower 20 moves the sprayer 50 (FIG. 4) so that the sprayer continues to spray treatment liquid 150 generally in region 55 of the tire as the tire 120 rotates, preferably until the whole exposed and outer sidewall of the tire has been sprayed with treatment liquid 150. Optionally, the control 60 can be calibrated to move the follower 20 at a speed along the rail 32 that is substantially the same as the vehicle speed as the vehicle 100 along the travel path 110.

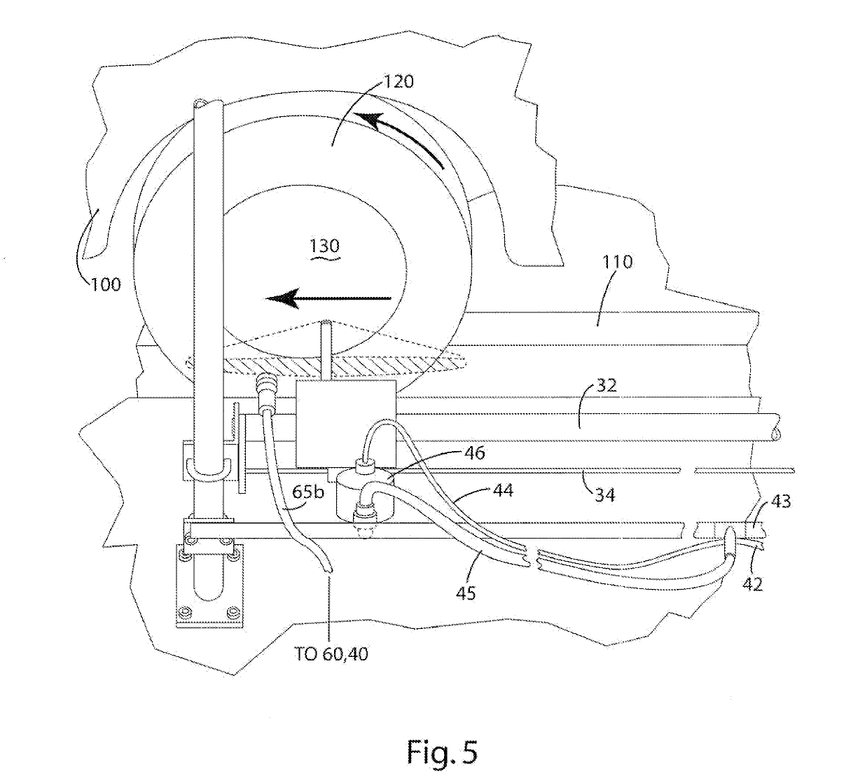

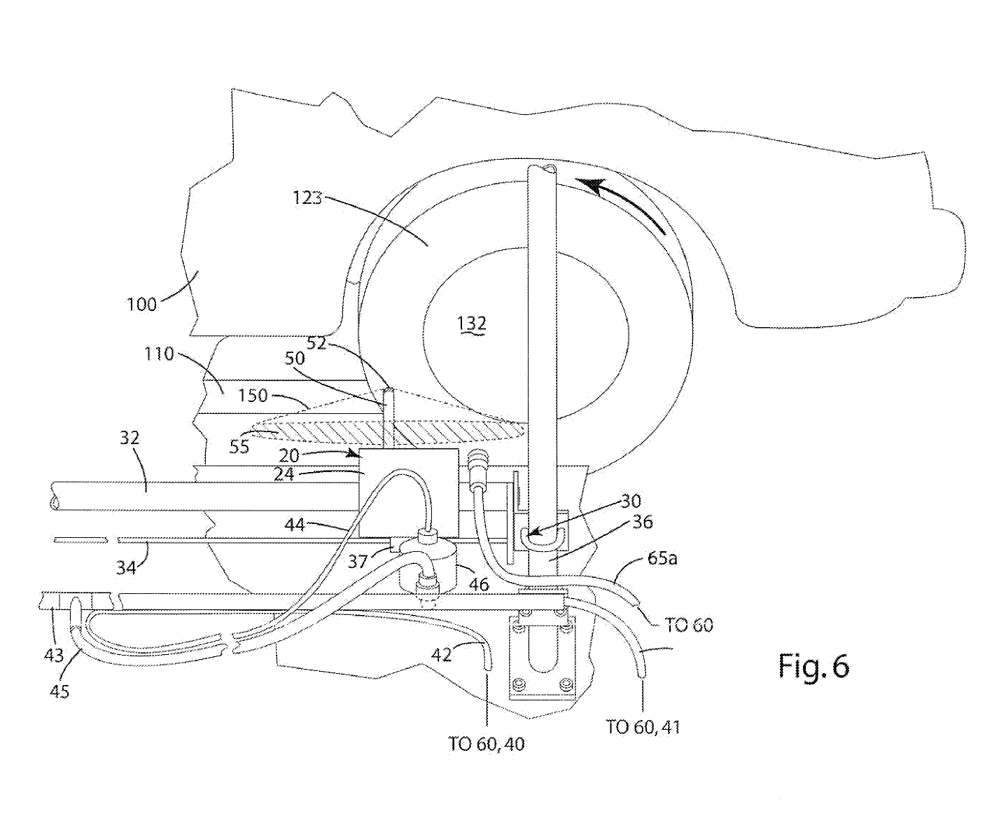

When the tire 120 reaches the end position 8 (FIGS. 5, 8), the follower 20 can be operated by control 60 through the drivers 65, 66 (FIG. 9), to return to the start position 6 and repeat the process with respect to the second tire 123 of the vehicle (FIG. 6).

The return of the follower 20 from the end position 8 to the start position 6 can be triggered in a variety of ways. As noted in the example above, the control 60 can monitor the amount of time that the follower moves. After a preselected time, e.g., six seconds, the controller can control the pneumatic system and return the follower 20 to the start position. In another example, the sensor 62 can detect how far the follower 20 moves along the guide rail, and return the follower 20 after it travels a specific distance. In a further example, the sensor 62 can detect the presence of the second tire 123 nearing the start position 6 and the control 60 can return the follower 20 in response to this second tire sensing.

IV. Alternative Embodiment

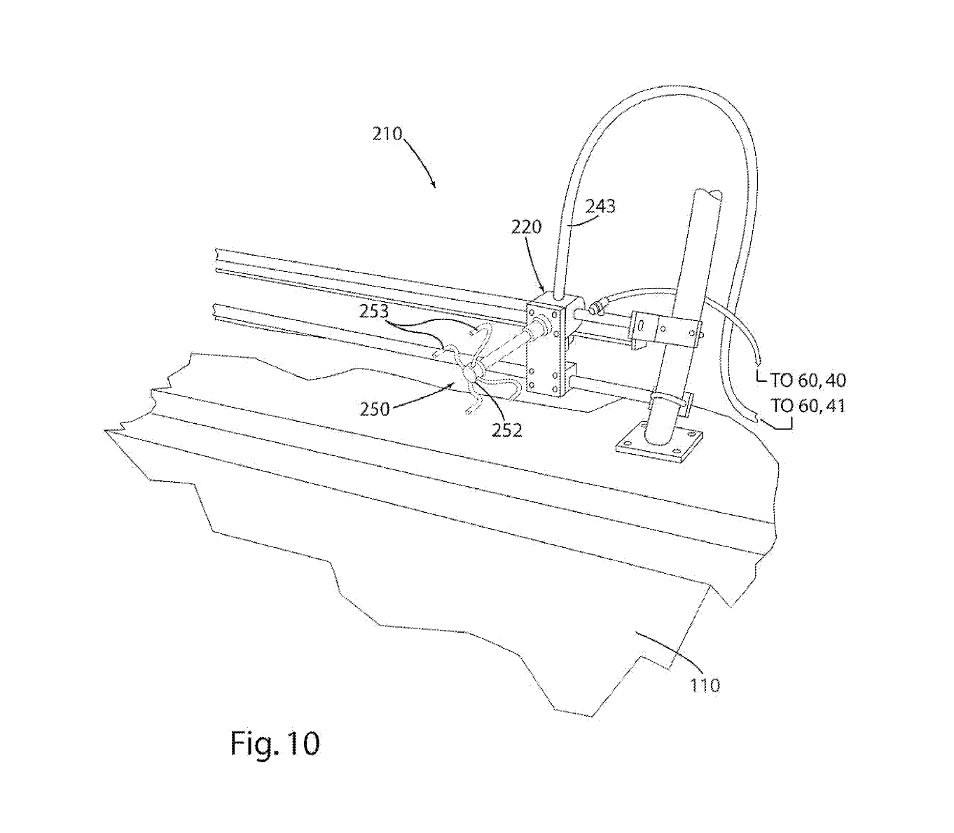

An alternative embodiment of the tire applicator 210 is shown in FIG. 10. In this embodiment, most components are similar to that described in the above embodiment. The differences are as follows: First, stationary tubing is absent from this construction. A flexible hose 243 of sufficient length is secured to the follower 220 and in fluid communication with the sprayer 250. Second, the sprayer 250 includes a head 252 with multiple nozzles 253. The spray nozzles may be configured to project a cone-shaped or other shaped spray. The spray nozzles 253 can optionally rotate relative to the head when applying treatment liquid to the tire. Optionally, the spray nozzles 253 can be at an angle with respect to the axis of the head 252. This alternative embodiment can be moved and controlled in the same manner as the embodiment described above.

The above descriptions are those of the preferred embodiments of the invention. Various alterations and changes can be made without departing from the spirit and broader aspects of the invention as defined in the appended claims, which are to be interpreted in accordance with the principles of patent law including the doctrine of equivalents. Any references to claim elements in the singular, for example, using the articles “a,” “an,” “the,” or “said,” is not to be construed as limiting the element to the singular.

1. A treatment liquid tire applicator comprising:
a support positioned along a travel path of a vehicle, the vehicle including a tire having an exposed side that rotates as the vehicle moves along a travel path;
a follower joined with and movable relative to the support and adapted to move alongside the tire as the vehicle moves along the travel path;
a control in communication with the follower;
a sensor in communication with the control; and
a sprayer joined with the follower, the sprayer aimed at the exposed side of the tire of the vehicle,
wherein the sensor senses the presence of at least one of the tire and the vehicle and sends a signal to the controller,
wherein the controller receives the signal and initiates movement of the follower alongside the vehicle as the vehicles moves on the travel path,
wherein the sprayer sprays liquid on the tire as the tire rotates so that at least the entire exposed side of the tire is sprayed with the sprayer upon substantially complete rotation of the tire.

2. The treatment liquid tire applicator of claim 1 wherein the sprayer is aimed at substantially only a location corresponding to a bottom portion of the exposed side of the tire and wherein the sprayer sprays liquid on substantially only the bottom portion of the exposed side of the tire.

3. The treatment liquid tire applicator of claim 2 wherein sprayer includes a fan spray nozzle and the fan spray nozzle sprays a substantially linear region across the tire, the region immediately adjacent the lowermost portion of a rim to which the tire is joined.

4. The treatment liquid tire applicator of claim 3 wherein the spray nozzle is disposed at an angle of about 0° to about 10° from horizontal.

5. The treatment liquid tire applicator of claim 1 wherein the follower follows the vehicle along the travel path for a preselected distance.

6. The treatment liquid tire applicator of claim 1 wherein the control controls the follower so that after the entire exposed side of the tire is sprayed with the sprayer upon substantially complete rotation of the tire, the controller returns the follower to a start position to spray another tire of the vehicle.

7. The treatment liquid tire applicator of claim 1 comprising a flexible, movable line in fluid communication with at least one of the follower and the sprayer, wherein the follower moves relative to the support between a first support end and a second support end.

8. The treatment liquid tire applicator of claim 7 wherein the flexible, movable line is further connected to a stationary line about midway between the first support end and the second support end.

9. An applicator for applying treatment liquid to a line of a vehicle moving along a travel path comprising:
a support including a first end and a second end, the support being substantially parallel to at least a portion of the vehicle travel path;
a follower mounted to the support and movable between the first end and the second end; and
a sprayer joined with the follower, the sprayer adapted to spray a treatment liquid on the tire as the vehicle travels along the travel path,
wherein the sprayer moves with the follower alongside the vehicle as the vehicle travels along the travel path,
wherein the sprayer sprays the treatment liquid on the tire as the tire rotates to substantially treat at least one exposed side of the tire with the treatment liquid.

10. The applicator of claim 9 comprising a controller in communication with the follower, and a sensor in communication with the controller.

11. The applicator of claim 10 wherein the sensor senses at least one of the vehicle and the tire and sends a signal to the controller.

12. The applicator of claim 11 wherein the controller receives the signal and, in response thereto, initiates movement of the follower alongside the travel path.

13. The applicator of claim 12 wherein the controller initiates the sprayer to spray the treatment liquid at a sweet spot on the tire.

14. A method for applying a treatment liquid to a tire of a moving vehicle comprising:
sensing a vehicle moving along a travel path;
actuating a sprayer to spray a treatment liquid as the vehicle travels along the travel path; and
moving the sprayer alongside the vehicle as the vehicle travels along the travel path so that the sprayer sprays at least a portion of an exposed side of the tire as the tire rotates, thereby causing multiple portions of the exposed side of the tire to be treated with the treatment liquid sprayed from the sprayer moving alongside the vehicle.

15. The method of claim 14 wherein the sprayer is disposed at an angle of about 5° to about 10° from horizontal.

16. The method of claim 15 wherein the sprayer sprays a substantially linear region across the exposed side of the tire adjacent the lowermost portion of a rim to which the tire is joined.

17. The method of claim 14 comprising moving the sprayer with the tire of the vehicle until substantially all of the tire is treated with a treatment liquid, and then moving the sprayer adjacent a second tire of the vehicle.

18. The method of claim 17 comprising moving the sprayer alongside the vehicle to apply to the treatment liquid to at least a portion of the exposed side the second tire as the second tire rotates until substantially all of the exposed side of the second tire is treated with the treatment liquid.

19. The method of claim 14 wherein the sprayer is aimed at and directly sprays substantially only the bottom portion of the exposed side of the tire as the tire rotates.
